(19) United States
(12) Patent Application Publication
(10) Pub. No.: US 2025/0093499 A1
(43) Pub. Date: Mar. 20, 2025

(54) RADAR SENSOR

(71) Applicant: Robert Bosch GmbH, Stuttgart (DE)

(72) Inventors: Safiullah Khan, Leonberg (DE); Armin Himmelstoss, Weissach Im Tal (DE); Heiko Dominik Gulan, Westland, MI (US); Johannes Meyer, Ettlingen (DE)

(21) Appl. No.: 18/729,246

(22) PCT Filed: Feb. 6, 2023
(86) PCT No.: PCT/EP2023/052821

§ 371 Date: Jul. 16, 2024

(30) Foreign Application Priority Data
Mar. 22, 2022 (DE) 10 2022 202 797.3

(51) Int. Cl. G01S 13/931; G01S 7/03; H01P 5/107; H01Q 1/22; H01Q 1/38; H01Q 21/00; H01Q 21/24

(52) U.S. Cl. CPC G01S 13/931; G01S 7/03; H01P 5/107; H01Q 1/2283; H01Q 1/38; H01Q 21/0006; H01Q 21/24

(57) ABSTRACT

A radar sensor. The radar sensor includes a high-frequency component and an antenna arrangement, which are arranged on opposite sides of a circuit board. The radar sensor includes a coupling structure for coupling the antenna arrangement to the high-frequency component by signals. The circuit board has an aperture which is sized such that it is permeable to microwave radiation, in that the high-frequency component is connected to the circuit board by a multilayer connection structure which covers the aperture. The coupling structure includes a resonator element that is embedded in the connection structure and configured to radiate microwave radiation through the aperture into the antenna arrangement.

### FIELD

The present invention relates to a radar sensor with a high-frequency component and an antenna arrangement, which are arranged on opposite sides of a circuit board, and with a coupling structure for coupling the antenna arrangement to the high-frequency component by signals.

In particular, the present invention relates to a radar sensor suitable for use in driver assistance systems or autonomous driving systems for motor vehicles.

### BACKGROUND INFORMATION

U.S. Patent Application Publication No. US 2020/365971 A1 describes a radar sensor of the aforementioned type, in which the coupling of the antenna arrangement to the high-frequency component takes place via electrically conductive through-connections in the circuit board. However, with this design principle, low-loss signal transmission is only possible if very narrow tolerances are met during the manufacture.

U.S. Patent No. U.S. Pat. No. 11,031,681 B2 shows an example of a radar sensor in which the antenna and the high-frequency component are located on the same side of the circuit board.

However, with this design principle, the design freedom in the arrangement of the components of the radar sensor on the circuit board is limited. The specified geometric arrangement of the antenna elements on the circuit board generally requires relatively long and lossy signal paths.

### SUMMARY

An object of the present invention is to provide a low-loss radar sensor of the aforementioned type that is easier to produce.

According to the present invention, this object may be achieved in that the circuit board has an aperture which is sized such that it is permeable to microwave radiation, in that the high-frequency component is connected to the circuit board by a multilayer connection structure which covers the aperture, and in that the coupling structure comprises a resonator element that is embedded in the connection structure and designed to radiate microwave radiation through the aperture into the antenna arrangement.

In this solution, the resonator element, which is used to couple the antenna arrangement to the high-frequency component, is embedded in a so-called interposer, which mechanically and electrically connects the high-frequency component to the circuit board. The signal coupling in the direction perpendicular to the plane of the circuit board takes place by electromagnetic radiation so that through-connections, which would allow only narrow manufacturing tolerances, are required neither in the circuit board nor in the interposer.

Advantageous configurations of the present invention are disclosed herein.

Embodiment examples of the present invention are explained in more detail below with reference to the figures.

### BRIEF DESCRIPTION OF THE DRAWINGS

FIG. 1 shows a section through a portion of a radar sensor according to an embodiment example of the present invention.

FIGS. 2-4 show partial sections through radar sensors according to further embodiment examples of the present invention.

FIGS. 5-7 show sections through different layers of an interposer in the embodiment example according to FIG. 2.

FIG. 8 shows a section, analogous to FIG. 7, for a modified embodiment example of the present invention.

FIG. 9 shows a layout sketch of a high-frequency component on an interposer with a plurality of coupling structures, according to an example embodiment of the present invention.

FIG. 10 shows a layout sketch of waveguide elements assigned to the coupling structures according to FIG. 9.

FIG. 11 shows a layout of a complete radar sensor.

FIG. 12 shows an example of a coupling structure with two feed points for microwave signals.

FIG. 13 shows a coupling structure with two resonance elements for different vibration modes.

FIGS. 14-16 show further examples of arrangements of resonance elements with different vibration modes.

FIGS. 17A-17D show examples of multi-channel feed systems for the coupling structures according to FIGS. 15 and 16.

### DETAILED DESCRIPTION OF EXAMPLE EMBODIMENTS

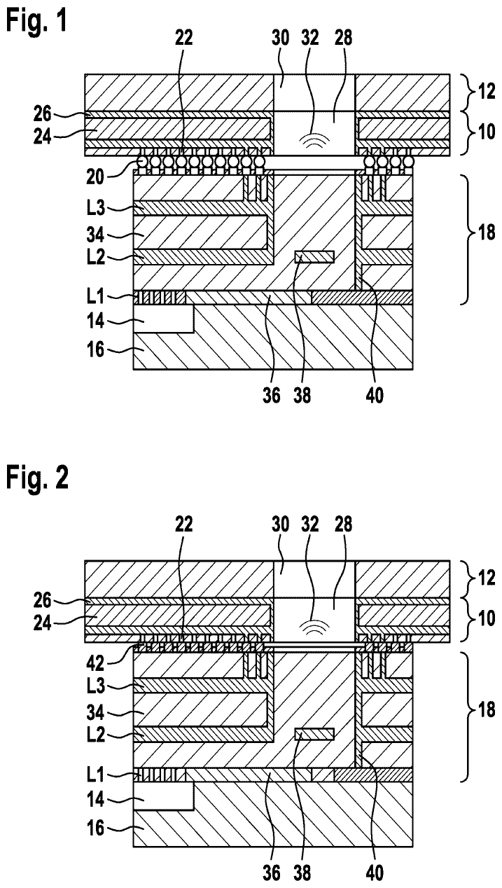

FIG. 1 shows a partial section through a radar sensor. The radar sensor comprises a circuit board 10 on which, on one side, on the top side in the example shown, an antenna arrangement 12 is formed and which carries, on the bottom side, a high-frequency component 14, which may be an MMIC (monolithic microwave integrated circuit), for example.

The high-frequency component 14 is embedded in a molded body 16 made of plastic and is mechanically and electrically connected to conductive paths 22 of the circuit board 10 by a connection structure, which is referred to as an interposer 18 below, and a so-called BGA 20 (ball grid array; i.e., an arrangement of solder balls).

As usual, the circuit board 10 has an alternating sequence of dielectric layers 24 and electrically conductive layers 26, some of which (not shown in the simplified illustration) form the conductive paths 22. An aperture 28 that is aligned with a waveguide element 30 of the antenna arrangement 12 is formed in the circuit board. In the example shown, the walls of the aperture 28 are metalized and are grounded via electrically conductive layers on the top side and the bottom side of the circuit board 10. The dimensions of the aperture 28 are so large that electromagnetic waves 32, whose wavelength is determined by the frequency band of the radar sensor, can propagate through the aperture into the waveguide element 30.

The interposer 18 also has an alternating sequence of dielectric layers 34 and electrically conductive layers L1, L2, L3. The lower layer L1, which is directly adjacent to the high-frequency component 14, inter alia forms a feed line 36 for a resonator element 38 embedded in the interposer 18. The resonator element 38 is located within the layout of the aperture 28 and is formed by a patch in the electrically conductive layer L2 in the example shown. The resonator element 38 is surrounded by a cage 40 formed by grounded through-connections extending to the surface of the interposer that is adjacent to the BGA 20. Within the cage 40, the electrically conductive layers L2 and L3 are interrupted so that the resonator element 38 is completely embedded in non-conductive material. Via the feed line 36, a microwave signal generated in the high-frequency component 14 can be electromagnetically coupled into the resonator element 38. The spacings between the “bars” of the cage 40 are small in relation to the wavelength of the microwave radiation so that the cage acts like a waveguide through which the resonator element 38 can radiate the microwave power in a directed manner into the aperture 28 and then finally into the waveguide element 30. It is understood that the BGA 20 is also interrupted at the point of the aperture 28.

FIG. 2 shows a modified embodiment example, which differs from the embodiment example according to FIG. 1 only in that the contacting of the interposer 18 does not take place via a BGA but via an LGA 42 (land grid array; arrangement of contact surfaces).

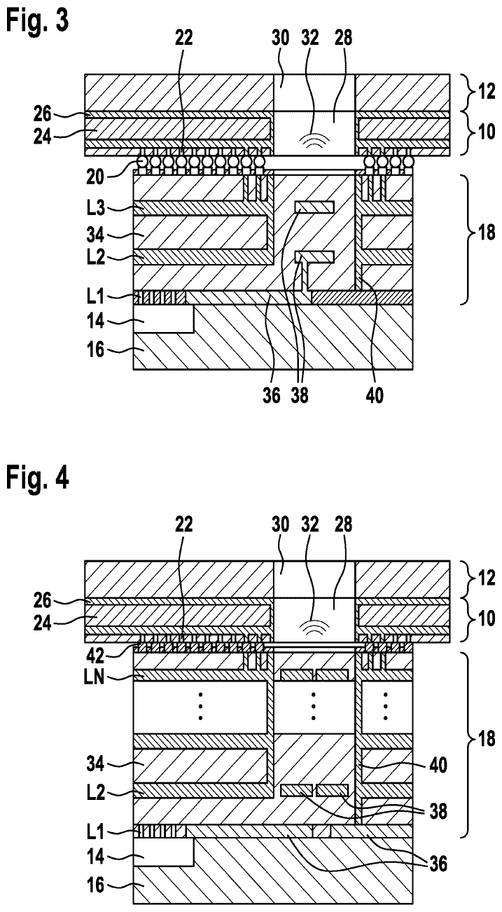

FIG. 3 shows an embodiment example that differs from the embodiment examples according to FIGS. 1 and 2 in that the resonator element 38 is galvanically connected to the feed line 36. In addition, in this example, a second resonator element 38 is formed in the electrically conductive layer L3. The distance between the two resonator elements is adapted to the wavelength such that a greater directivity is achieved when the microwave power is coupled into the waveguide element 30.

The contacting of the interposer 18 in this example takes place via a BGA, but an LGA would optionally also be possible. This is true for all embodiment examples described in this application.

FIG. 4 schematically shows an embodiment example in which the interposer 18 comprises a greater number of electrically conductive layers L1-LN. The number of layers in which resonator elements 38 are formed may be 1, 2, or more.

FIG. 4 furthermore illustrates an example of a configuration in which two or more separately fed resonator elements 38 are arranged in the same layer L2. The associated feed lines 36 are connected to different outputs of the high-frequency component 14, although this is not shown in FIG. 4. The coupling to the resonator elements 38 takes place electromagnetically in this example.

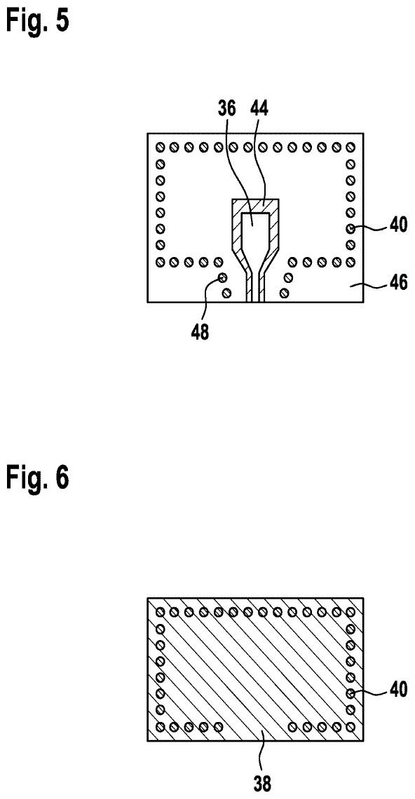

FIG. 5 shows a section through the cage 40 at the height of the top side of the layer L1 in FIG. 2. The individual bars of the cage 40 can be seen in section here. An end of the feed line 36, which end is separated from a grounded metallization layer 46 by a gap 44 (coplanar wave guide), can also be seen. The grid 40, in which a passage 48 for the feed line 36 is formed, is also grounded via the metallization layer.

FIG. 6 shows a section through the cage 40 at the height of the dielectric layer 38, which separates the conductive layers L1 and L2 from one another.

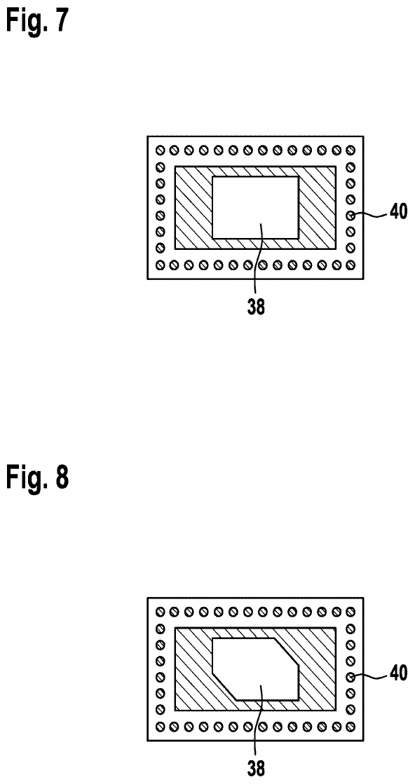

FIG. 7 shows a section at the height of the top side of the resonator element 38, which in this case is formed as a rectangular patch. Inside the cage 40, this patch generates a linearly polarized vibration mode, the polarization direction of which is dependent on the orientation of the rectangle.

Alternatively, the patch may also have the shape of a rectangle in which two diagonally opposite corners are “cut off,” as shown in FIG. 8. As is conventional, a patch with this geometry generates a circularly polarized vibration mode. If necessary, the geometry of the cage 40 can be adapted to the vibration mode to be excited predominantly.

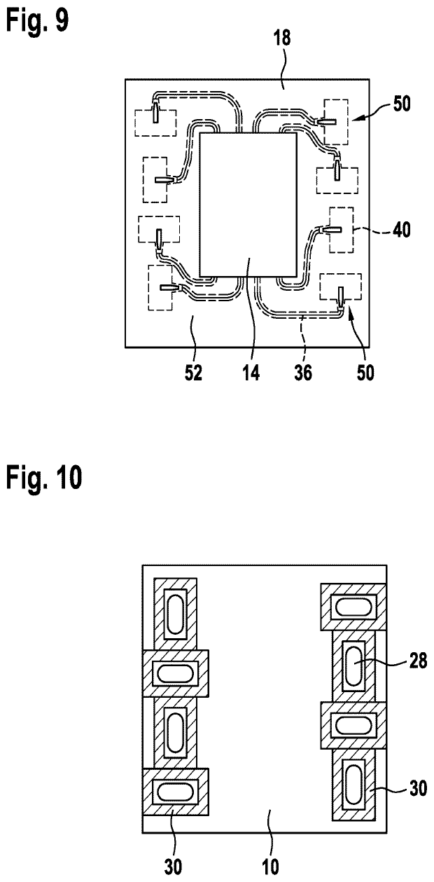

FIG. 9 shows the semiconductor component 14 and the associated interposer 18 in a schematic layout. Eight coupling structures 50, which each couple to a waveguide element (not shown here) corresponding to the waveguide element 30 in FIG. 1, are embedded in the interposer 18 in this example. Each coupling structure 50 is formed by a cage 40 containing at least one resonator element 38. The resonator elements 38 of each coupling structure 50 are respectively connected to an output of the semiconductor component 14 via a feed line 36. In the layer directly above the feed lines 36, each cage 40 has a passage 48 (FIG. 5). The bars of this passage transition into a gallery of through-connections 52 that flank the feed line 36 formed as a coplanar waveguide.

FIG. 10 shows a section through the waveguide elements 30, which are located on the top side of the circuit board 10 and assigned to the coupling structures 50 shown in FIG. 9. Through the waveguide elements 30, the apertures 28 of the circuit board 10 can be seen here. These apertures are, for example, formed by a series of bores whose circular cross-sections overlap one another so that the aperture in the layout approximately has the shape of an oval.

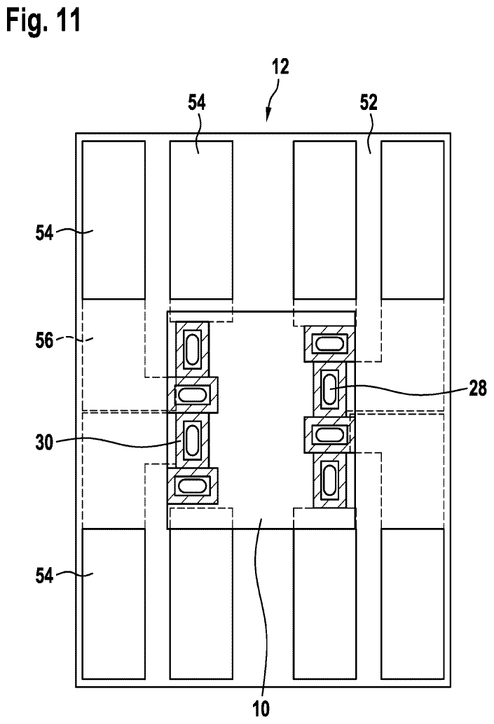

FIG. 11 shows a complete radar sensor in plan view. The antenna arrangement 12 comprises a housing 52, which is held on the circuit board 10 but projects above it in the layout. The housing 52 receives eight waveguide antennas 54 arranged in two parallel rows. Each of these waveguide antennas 54 is connected to one of the waveguide elements 30 on the circuit board 10 via a connecting element 56 (drawn dashed), which is likewise designed as a waveguide, the waveguide elements coupling to the resonator elements 38 (not shown in FIG. 11) via the apertures 28 in the circuit board.

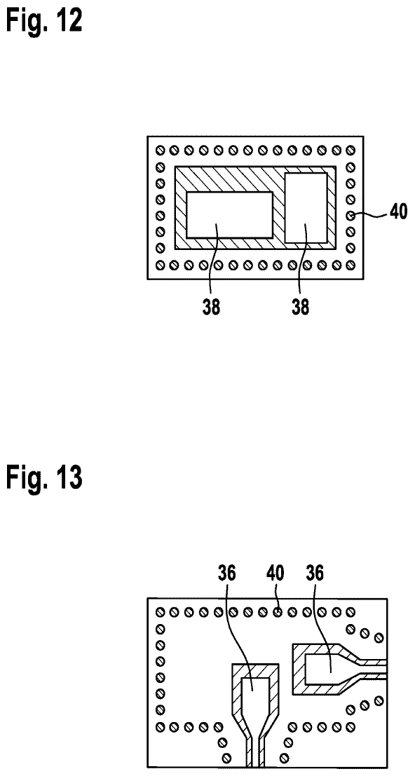

In order to create a broadband and flexibly configurable radar sensor, the number, the shape, and the arrangement of the coupling structures 50 can be varied in a variety of ways. As an example, FIG. 12 shows a coupling structure with two resonator elements 38, which are arranged in the same layer of the interposer and are both formed as rectangular patches that differ in their orientation by 90°. FIG. 13 shows the associated feed lines 36, which are likewise oriented orthogonally to one another. The two patches can be used to generate linearly polarized radiation fields whose polarization directions are rotated by 90° relative to one another. This arrangement may, for example, be used to switch between two polarization directions orthogonal to one another, by feeding either the one or the other resonator element 38. Alternatively, both resonator elements may also be fed simultaneously so that a diagonal or circular polarization results depending on the phase relationship of the feed signals.

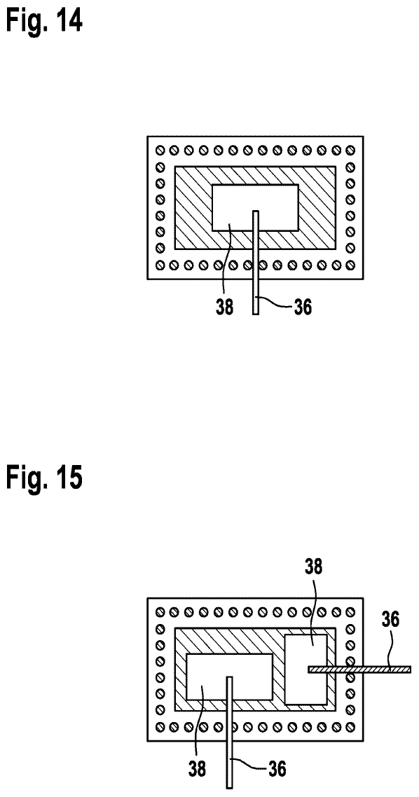

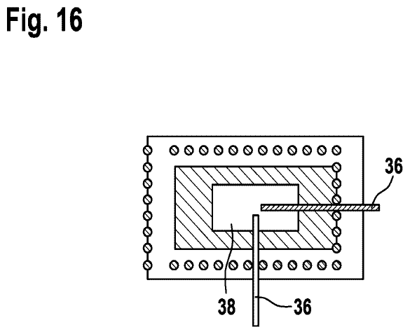

FIGS. 14 to 16 show various configurations of resonator elements 38 and feed lines 36. Similarly to FIGS. 12 and 13, the arrangement according to FIG. 15 can be used to generate two vibration modes with polarizations that are orthogonal to one another. In FIG. 16, only a single rectangular resonance element is provided per interposer layer but can be fed via feed lines 36 oriented orthogonally to one another. In this case, it is also possible to generate two vibration modes with polarizations that are orthogonal to one another.

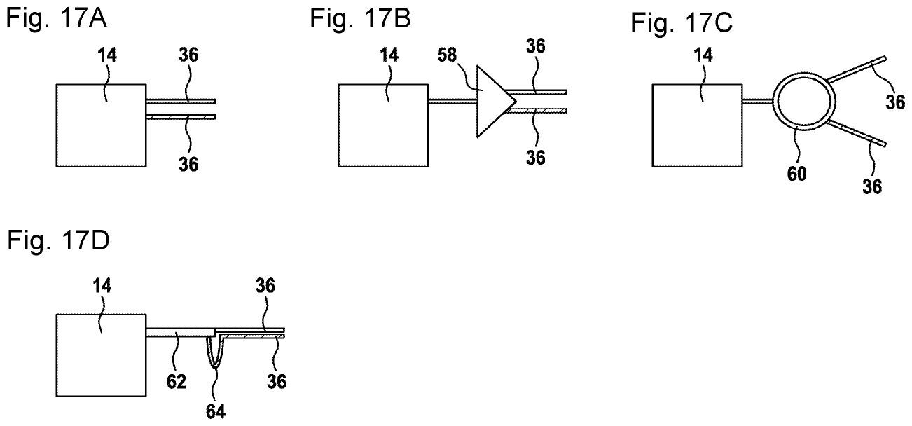

For better distinction, FIGS. 15 and 16 show one of the two feed lines 36 shaded and the other non-shaded. FIGS. 17A-17D illustrates examples of different systems for feeding the microwave signal into these feed lines. In FIG. 17A, the two feed lines 36 are connected directly to two different outputs of the high-frequency component 14. In FIG. 17B, the two feed lines are connected to two outputs of a transformer or amplifier 58, which is in turn connected to an output of the high-frequency component 14. This arrangement allows the two resonator elements to be fed synchronously with in-phase signals.

In FIG. 17C, a ring coupler 60 is connected to an output of the high-frequency component 14, and the feed lines 16 are connected to the ring coupler 60 in such positions that they tap signals with different phase positions.

In FIG. 17D, the two feed lines 36 are connected to one output 62 of the high-frequency component 14. While one of the two feed lines is connected directly to the output 62, the other feed line has a detour line 64 the length of which determines the phase position of the signals fed into the resonance elements 38.

It is understood that, in addition to the layer L1 of the interposer 18 that forms the feed lines 36, at least one further electrically conductive layer of the interposer can form resonance elements 38, which each have the same shape and arrangement as the resonance elements in FIGS. 14 to 16 but do not have their own feed lines but rather are excited to vibrate by electromagnetic coupling to the layer L1.

While the feed lines 36 in the embodiment examples described so far are designed as coplanar waveguides, variants in which the feed line is designed as an SIW (substrate integrated waveguide) are also possible for all described embodiments. These SIW waveguides are bounded at the top side and bottom side by grounded, electrically conductive layers of the interposer and are bounded in the horizontal direction, similarly to the cages 40, by galleries of through-connections.

1-12. (canceled)

13. A radar sensor, comprising:
a high-frequency component and an antenna arrangement, which are arranged on opposite sides of a circuit board;
a coupling structure configured to couple the antenna arrangement to the high-frequency component by signals;
wherein the circuit board has an aperture which is sized such that it is permeable to microwave radiation, the high-frequency component is connected to the circuit board by a multilayer connection structure which covers the aperture, and the coupling structure include a resonator element that is embedded in the connection structure and is configured to radiate microwave radiation through the aperture into the antenna arrangement.

14. The radar sensor according to claim 13, wherein the antenna arrangement includes at least one waveguide element which is directed toward the aperture and receives and forwards the microwave radiation generated by the resonator element.

15. The radar sensor according to claim 13, wherein the resonator element is arranged in a cage that serves as a waveguide and walls of the cage are formed by through-connections in the multilayer connection structure.

16. The radar sensor according to claim 13, wherein at least two electrically conductive layers of the connection structure each respectively contain at least one resonator element, wherein the resonator elements are congruent with one another in the different layers.

17. The radar sensor according to claim 13, wherein at least two resonator elements are arranged in the same layer of the connection structure.

18. The radar sensor according to claim 16, wherein at least two feed lines connecting the high-frequency component to the resonator elements are configured such that different vibration modes of the microwave radiation are excitable by different types of feeding of microwave power into the feed lines.

19. The radar sensor according to claim 18, wherein each of a plurality of resonator elements that are located in the same layer of the connection structure has its own feed line.

20. The radar sensor according to claim 18, wherein two feed lines are connected to the same resonator element such that vibration modes with different polarization are excitable depending on a choice of the feed line.

21. The radar sensor according to claim 19, wherein the resonator elements are electromagnetically coupled to their respective feed line.

22. The radar sensor according to claim 19, wherein the resonator elements are galvanically coupled to their respective feed line.

23. The radar sensor according to claim 18, wherein at least one of the feed lines is a coplanar waveguide.

24. The radar sensor according to claim 18, wherein at least one feed line is an SIW waveguide.
